(19) United States
(12) Patent Application Publication
(10) Pub. No.: US 2018/0043615 A1
(43) Pub. Date: Feb. 15, 2018

(54) 3D Printer Having a Coater and Coater Cleaning Device and Method for Cleaning a Coater of a 3D Printer

(71) Applicant: ExOne GmbH, Gersthofen (DE)

(72) Inventors: Rainer HÖCHSMANN, Langenneufnach (DE); Alexander MÜLLER, Diedorf-Vogelsang (DE); Sven KLAUA, Augsburg (DE)

(73) Assignee: ExOne GmbH, Gersthofen (DE)

(21) Appl. No.: 15/554,387

(22) PCT Filed: Jan. 28, 2016
(86) PCT No.: PCT/EP2016/051831

§ 371 Date: Oct. 3, 2017

(30) Foreign Application Priority Data
Mar. 13, 2015 (DE) 10 2015 103 726.2

(51) Int. Cl. B29C 64/165; B33Y 99/00; B29C 64/35

(52) U.S. Cl. CPC B29C 64/165; B29C 64/35; B33Y 99/00; B29C 64/227

(57) ABSTRACT

Disclosed is a 3D printer 10 having a coating device 30 and a coating device cleaning device 50, wherein the coating device 30 comprises a container 32 which defines an inner cavity 34 for receiving particulate construction material and an elongated output region 36 for outputting the particulate construction material and can be moved into a cleaning position in which it is arranged above the coating device cleaning device 50, wherein the coating device cleaning device 50 comprises a wiping member 54 and a driving device for moving the wiping member, and wherein the driving device is configured to move the wiping member 54 for cleaning the output region 36 along the same when the coating device 30 is located above the coating device cleaning device 50.

The present invention relates to a 3D printer having a coating device and a coating device cleaning device as well as to a method for cleaning a coating device of a 3D printer. For example, the present invention relates to a 3D printer and a method for cleaning a coating device of a 3D printer according to the preamble of claim 1 and the preamble of claim 12, respectively. A 3D printer of this type and a cleaning method of this type, respectively, is, for example, known from DE 10 2009 056 687 A1.

Various generative/additive manufacturing processes (and consequently various types of 3D printers, i.e. machines/arrangements for building up a component in layers) are known.

Some generative manufacturing processes have the following steps in common:

(1) First, particulate material is applied over the entire surface of a construction field, so as to form a layer of unsolidified particulate material.

(2) The applied layer of unsolidified particulate material is selectively solidified in a predetermined partial area, for example by selectively printing a treatment agent, for example a binder (alternatively, for example, by laser sintering).

(3) Steps (1) and (2) are repeated to manufacture a desired component. For this purpose, a construction platform on which the component is built up in layers may, for example, be lowered by respectively one layer thickness before a new layer is applied over the entire surface (alternatively, the coating device and the printing device may, for example, be raised by respectively one layer thickness).

(4) Finally, the manufactured component which is supported and surrounded by loose, unsolidified particulate material may be unpacked.

The construction space in which the component or the components is/are manufactured may, for example, be defined by a so-called construction box (also referred to as “job box”). A construction box of this type may have a circumferential wall structure which is open in an upward direction and extends in a vertical direction (for example formed by four vertical side walls), which may, for example, be formed to be rectangular when viewed from above. A height-adjustable construction platform may be received in the construction box. In this respect, the space above the construction platform and between the vertical circumferential wall structure may for example at least contribute to forming the construction space. An upper area of the construction space may, for example, be referred to as construction field. An example of such a construction box is, for example, described in DE 10 2009 056 696 A1.

A coating device (also referred to as a “recoater”) is normally used in the above step (1). Various coating devices are known for use in a 3D printer, by means of which a particulate construction material may be applied to the construction field (also referred to as construction surface or construction area) in the form of a uniform layer over the entire surface.

One type of coating device uses a roller (short: “roller coating device”) in front of which first an amount of particulate construction material is put down and which is then horizontally moved across the construction field to apply the particulate construction material onto the construction field in the form of a uniform layer. In this respect, the roller may be rotated opposite to the moving direction. Coating device arrangements with great lengths (and consequently 3D printers of large dimensions) are difficult to realize using a roller coating device, amongst others because of a possible deflection of the roller.

Another kind of coating device (a so-called “container coating device”, for example a “slot coating device”) uses a container which defines an inner cavity for receiving particulate construction material, and has an elongate output region (for example comprising an output slot) for outputting the particulate construction material. The container coating device may, for example, be movable across a construction field (for example horizontally, for example transverse to the longitudinal direction), so that the particulate construction material can be output through the elongate output region onto the construction field, to thereby apply a uniform construction material layer over the entire surface of the construction field. The coating device may be elongate, for example to span or cover the length or width of a rectangular construction field. Coating device arrangements having great lengths (and consequently 3D printers of large dimensions) may be realized properly using a container coating device.

In the above step (2), a printing device having a print head may for example be used, which applies a treatment agent in a controlled way onto a subarea of the construction material layer applied before. The treatment agent contributes to a (direct and/or subsequent) solidification of the construction material layer in the subarea. For example, the treatment agent may be a binder, for example a binder component of a multicomponent binder.

Alternatively, a laser may, for example, be used in the above step (2) to solidify a subarea of the construction material layer applied previously, for example by sintering or melting the construction material in the subarea.

The present invention relates to a 3D printer having a coating device of the above-described second type, briefly a “container coating device”, for example a “slot coating device”.

A coating device of this type may, for example, be provided with a stroking/sweeping member by which construction material applied to the construction field is stroked, to thereby compress and/or level the construction material. The stroking/sweeping member may be arranged adjacent to the output slot and/or may delimit the same, and may form the so-called output region of the coating device container together with the output slot.

An example of a “slot coating device” is known from DE 10 2009 056 689 A1. See therein, for example, FIGS. 17 to 20.

It is, in addition, known to provide a 3D printer with a coating device cleaning device by means of which construction material adhering to the lower side of the container may be removed and/or wiped off, and/or by means of which the longitudinal slot of the container may be wiped off, in order to release obstructions, if necessary. See DE 10 2009 056 687 A1; therein, for example, see FIGS. 21, 24 and 25.

The coating device cleaning device known from DE 10 2009 056 687 A1 comprises an elongate wiping member which is received at least in part in a construction material collection container underneath the coating device container. The wiping member is supported rotatably and can be driven rotatably by means of a wiping member driving mechanism.

It may be considered as being an object of the invention to provide a coating device cleaning device (and/or a corresponding 3D printer) which is alternative and/or improved with respect to the above-mentioned coating device cleaning device, and to indicate an alternative and/or improved coating device cleaning method, respectively.

For this purpose, the present invention provides a 3D printer according to claim 1, a 3D printer according to claim 11 and a method according to claim 12. Further embodiments of the 3D printer according to the invention and of the method according to the invention are described in the dependent claims.

According to various aspects of the present invention, a 3D printer having a coating device and such a coating device cleaning device may be provided, by means of which an improved/good cleaning result can be achieved and/or which can be realized easily and/or cost-efficiently, for example also for long coating devices and/or 3D printers of large dimensions, and/or which cleans the coating device reliably, in a fail-safe and efficient way.

According to various aspects of the present invention, a 3D printer having a coating device and such a coating device cleaning device may be provided, by means of which construction material adhering to the output region of the container may be reliably removed and wiped off, respectively, and/or by means of which the output region of the container may be wiped off reliably, in order to break obstructions, if necessary.

According to various aspects of the present invention, a 3D printer having a coating device and a coating device cleaning device is provided, wherein the coating device comprises a container which defines an inner cavity for receiving particulate construction material, and an elongate output region for outputting the particulate construction material and can be moved into a cleaning position in which it is arranged above the coating device cleaning device, the coating device cleaning device comprising a wiping member and a driving device for moving the wiping member, and wherein the driving device is configured to move the wiping member for cleaning the output region along the same when the coating device is located above the coating device cleaning device.

The 3D printer may, for example, be configured to carry out the initially described generative manufacturing method, at least steps (1) to (3).

The 3D printer may, for example, comprise a construction space as described initially, in which the component or the components is/are manufactured and which is, for example, defined by a so-called construction box (also referred to as “job box”). A construction box of this type may have a circumferential wall structure which is open in an upward direction and extends in a vertical direction (for example formed by four vertical side walls), which may, for example, be formed to be rectangular when viewed from above. A height-adjustable construction platform may be received in the construction box. In this respect, the space above the construction platform and between the vertical circumferential wall structure may for example at least contribute to forming the construction space. An upper area of the construction space may, for example, be referred to as construction field.

The 3D printer may, for example, comprise a printing device having a print head configured to apply a treatment agent in a controlled way onto a partial area of a previously applied construction material layer. In this respect, the treatment agent may contribute to a (direct and/or subsequent) solidification of the construction material layer in the subarea. For example, the treatment agent may be a binding agent, for example a binder component of a multi-component binder. Additionally or alternatively, the 3D printer may, for example, comprise a laser device which is configured to solidify a subarea of a previously applied construction material layer, for example by sintering or melting the construction material in the subarea.

The coating device (or “recoater”) is configured as a so-called “container coating device”, for example as a “slot coating device” (i.e.

having a discharge slot). The container coating device may, for example, be movable across a construction field (for example horizontally, for example transverse to its longitudinal direction), so that the particulate construction material can be output onto the construction field through the elongate output region, to thereby apply a uniform construction material layer over the entire surface of the construction field. The coating device may be elongate, in order to span or cover, for example, the length or width of a rectangular construction field.

The container may, for example, have an elongate shape, in order to span or cover, for example, the entire length or the entire width of a rectangular construction field. The inner cavity of the container may, for example, form a shaft/duct which in cross-section is, for example, tapered in a downward direction (at least in sections) and/or has a funnel shape. The inner cavity for receiving particulate construction material may, for example, lead to the elongate output region, for example the (elongated) output slot described below, and may be connected to the same, respectively.

The 3D printer may, for example, comprise a stationary filling station into which the coating device can be moved, in order to fill the container with (fresh) construction material.

The container may, for example, be supplied with construction material by a charging container travelling along with the same.

A distribution device for distributing the construction material may, for example, be received in the optional charging container and/or the container, for example in the form of a distributing worm.

According to various embodiments, the elongate output region may, for example, comprise an (elongated) output slot and/or one or more (for example one or two) elongate stroking/sweeping surfaces (for example it may consist thereof), which are configured to stroke construction material output from the container (for example construction material applied onto a construction field during a normal operation/coating operation), in order to thereby level and/or compress the output construction material. The at least one (effective) stroking/sweeping surface may, for example, be provided by a stroking/sweeping member which may, for example, be provided in the form of a so-called stroking bar/strip and/or stroking blade, for example by a portion of the stroking member oriented in a downward direction, which may, for example, project/protrude downward, for example in a stepped way. For example, the (respective) stroking/sweeping surface may be configured to be planar and/or in strip shape. The one or more stroking/sweeping surfaces and stroking/sweeping members may, for example, be arranged adjacent to the output slot and/or may delimit the same, for example each in a transverse direction. For example, the output slot may be arranged in a transverse direction between two stroking/sweeping surfaces and stroking/sweeping members. Thereby, the coating device can be formed and/or operated as a bidirectional coating device, the stroking/sweeping surface located at the rear in the direction of travel being respectively active. In this respect, at least the respectively active stroking/sweeping surface (for example the entire coating device) may for example be tilted to adjust a so-called set angle of the stroking/sweeping surface with respect to the construction field and thereby a degree of compression of the particulate material. The one or more stroking/sweeping members may, for example, be fixed to and/or suspended from a carrier structure of the coating device, for example together with an optional closing device for selectively closing the output slot. Said carrier structure may, for example, extend transverse to the direction of movement of the coating device and/or in a longitudinal direction of the coating device. The container may be fixed to the carrier structure as well, for example separately from the optional at least one stroking/sweeping member and/or the optional closing device.

For example, the elongate output region and/or the (elongated) output slot and/or the one or more elongate stroking/sweeping surfaces may be directed downward, for example toward the construction field. The elongate output region and/or the (elongated) output slot and/or the one or more elongate (effective) stroking/sweeping surfaces may have a first extension in a longitudinal direction and a second extension in a transverse direction, the first extension being greater than the second extension, for example at least by the factor 2, 3, 4, 5, 6, 7, 8, 9, 10, 11, 12, 13, 14, 15, 16, 17, 18, 19, 20 or more. For example, the elongate output region and/or the (elongated) output slot and/or the respective stroking surface may substantially have a rectangular shape and/or a strip shape when viewed from above.

The cleaning position into which the coating device can be moved and the coating device cleaning device, respectively, can, for example, be arranged adjacent to the construction field.

The coating device cleaning device may, for example, be configured to be stationary, i.e. fixed.

The wiping member of the coating device cleaning device may, for example, have an extension in the above-mentioned longitudinal direction, which is shorter than the first extension of the elongate output region and/or of the (elongated) output slot and/or of the one or more elongate (effective) stroking/sweeping surfaces, for example resulting in a ratio (wiping member extension : first extension) of less than or equal to 1:2, less than or equal to 1:3, less than or equal to 1:4, less than or equal to 1:5, less than or equal to 1:6, less than or equal to 1:7, less than or equal to 1:8, less than or equal to 1:9, less than or equal to 1:10, less than or equal to 1:11, less than or equal to 1:12, less than or equal to 1:13, less than or equal to 1:14, less than or equal to 1:15, less than or equal to 1:16, less than or equal to 1:17, less than or equal to 1 to 18, less than or equal to 1:19 or less than or equal to 1:20.

The wiping member of the coating device cleaning device may, for example, have an extension in the above-mentioned transverse direction, which is substantially greater than or equal to the second extension of the elongate output region and/or of the (elongated) output slot and/or of the one or more elongate (effective) stroking/sweeping surfaces.

According to various embodiments, the output region (and/or the (elongated) output slot and/or the one or more elongate (effective) stroking/sweeping surfaces) may thus, for example, have a transverse extension, wherein the wiping member predominantly (i.e. a major part thereof) or substantially entirely underlaps the output region (and/or the (elongated) output slot and/or the one or more elongate (effective) stroking/sweeping surfaces) in the transverse direction thereof (when the coating device is in its cleaning position).

According to various embodiments, the wiping member may, for example, be configured as a brush or as a wiper blade or a wiper lip (for example as an elastic wiper blade/wiper lip). Using one or more brushes may, according to various aspects of the invention, facilitate a proper reproduction of the contour of the output region and, for example, of the output slot thereof, whereby a particularly good cleaning result can be achieved.

According to various embodiments, the coating device cleaning device may, for example, comprise a plurality of wiping members. Several wiping members may, for example be grouped into a group of wiping members, the wiping members of a group being arranged adjacent to each other and/or adjoining each other. In this respect, several groups may be provided which are arranged at a distance from each other.

The wiping member is movable by means of the driving device along the same for cleaning the output region (i.e., substantially in a longitudinal direction thereof and/or substantially along the length (of the output region), for example substantially along the entire length or a section thereof, which section is, for example, greater than or equal to half of the entire length, for example greater than or equal to ¾ of the entire length, for example greater than or equal to ⅘ of the entire length, for example greater than or equal to ⅚ of the entire length) when the coating device is located above the coating device cleaning device. Hereby, the output region is wiped off by the wiping member in a longitudinal direction, other than in the initially mentioned state of the art where the output region is wiped off by a rotating wiping member in a transverse direction.

The driving device may, for example, be connected to a controller/control unit and/or may be controlled by it and/or may comprise an electric drive.

As described, the driving device is configured to move the wiping member along the output region, i.e., substantially in a longitudinal direction thereof and/or substantially along the length (of the output region), for example substantially along the entire length or a substantial/major section thereof.

According to various embodiments of the present invention, an effective and/or efficient cleaning of the output region (for example of the output slot and/or of the at least one stroking/sweeping surface) may be achieved by wiping off the same in a longitudinal direction, for example with a cleaning effect that is improved when compared to the initially mentioned conventional cleaning device and/or with a resistance to be overcome by the drive which is reduced when compared to the initially mentioned conventional cleaning device.

According to various embodiments of the present invention, a proper cleaning of the output region (for example of the output slot and/or of the at least one stroking/sweeping surface) may be realized easily and in a cost-effective way by wiping off the same in a longitudinal direction, for example also for long coating devices or long output regions. In this respect, according to various aspects of the present invention, the elongate (for example roller-shaped) wiping member required for the conventional cleaning device can be dispensed with and, as the case may be, the length of the wiping member can be reduced, and the driving mechanism of the wiping member can be configured to be less strong, given that the resistance to be overcome can be reduced.

The driving device may, for example, be configured to move the wiping member linearly/in a straight line along the output region. In other words, the wiping member may travel along/wipe off the output region in a linear movement along the longitudinal direction thereof, in order to clean the same.

According to various embodiments, the wiping member may, for example, be movable linearly/in a straight line along the output region by means of a linear guide, for example by the wiping member being attached to a slide of the linear guide. In other words, the driving device may comprise a linear guide according to various embodiments. According to various embodiments, the wiping member may, for example, be movable exclusively along the output region or may be fixed in a height direction in this regard.

According to various embodiments, the driving device may, for example, be configured to move the wiping member (for example after cleaning the coating device) to a lowered position (for example a “parking position” or “idle position”), in order to avoid a collision with the coating device (for example during normal operation of the coating device). Thus, the wiping member may, for example, be movable back and forth between a lowered position and a position that is elevated when compared to the lowered position (for example “cleaning position” for cleaning the output region) by the driving device. In other words, the wiping member may thus be configured to be movable in a height direction as well, at least between the two mentioned positions in a height direction. Hereby, a particularly compact configuration of the 3D printer is possible, given that the coating device cleaning device may be arranged near the construction field or may rather be moved near the same without affecting the coating device in its usual operation (for example during the coating travels between a first and a second cleaning). In other words, it is thus possible to move the coating device without any collision across the cleaning device. Besides, it is possible to clean the wiping member itself in the lowered position, whereby in the end an even more improved cleaning of the coating device can be achieved.

According to various embodiments, the driving device may, for example, be configured to move the wiping member along a circulating path (for example a closed path/trajectory, for example comprising two straight sections and two curved, for example semicircular sections) which extends with a first path section along the output region (i.e., substantially in a longitudinal direction thereof and/or substantially along the length (of the output region), for example substantially along the entire length or along a substantial section thereof), when the coating device is in the coating device cleaning position. According to this embodiment, the wiping member does thus not perform any rotational movement by itself about its own rotational axis, but circulates around an external point. The first path section may, for example, be configured in a straight line and/or may extend parallel to the output region or at/in the same. Moving the wiping member along a circulating path is a possible way of moving the wiping member to the above-described lowered position in the meantime. In this respect, the circulating path may, for example, comprise a second path section which is arranged vertically below the first path section and vertically below the output region; in this respect, the second path section may, for example, be configured in a straight line as well and/or may extend parallel to the first path section. If the wiping member is located at the second path section, it may, for example, be oriented downward, i.e. averted from the output region, whereas it is oriented upward if it is located on the first path section.

According to various embodiments, the driving device may, for example, comprise an elongate carrier structure (for example a flexible and/or endless carrier structure), to which the wiping member is attached and which can be moved in a circulating way (for example an inner circulating path), to thereby move the wiping member along its circulating path. Hence, the driving device may, for example, be configured to move the elongate carrier structure along an inner circulating path by means of a driving means. The elongate carrier structure may, for example, be provided as a belt and/or a strap. The driving device may, for example, further comprise two or more deflection means (for example in the form of (belt) pulleys and/or rolls), about which the elongate carrier structure is wound/laid/guided, so that the carrier structure and thus the wiper blade is movable relative to the coating device by driving at least one of the deflection means (for example by means of an electric motor). For example, a first portion of the inner circulating path may extend at a (slight) distance to the output region substantially in the longitudinal direction thereof and/or may be arranged vertically below the output region and/or may be configured in a straight line and/or may extend parallel to the output region and/or may be arranged between the output region and the second portion in a height direction, which again may be formed in a straight line and/or may extend parallel to the output region and/or the first path section.

According to various embodiments, the coating device cleaning device may, for example, further comprise a sensor (for example a position sensor) which is configured to detect a position of the wiping member. For this purpose, a target to be detected by the sensor may be attached to the wiping member itself and/or may be formed by the same and/or may be attached to the above carrier structure and/or may be formed by the same. The sensor may, for example, be connected to the controller. The controller may, for example, be configured to control the driving device (for example an electric motor thereof) according to a position signal received by the sensor. Hereby, it is for example possible to make sure that a cleaning takes place reliably and as desired and/or that the wiping member is arranged in the above-described lowered position after cleaning.

When using a plurality of wiping members, these wiping members may, for example, together be movable into a respectively lowered position, in order to avoid a collision of the coating device with one or more of the wiping members. For example, in case of the above-described circulating path along which the wiping members are movable, the wiping members may be provided at such a distance from each other or relative to each other in such a way that they may all and/or together be arranged on the second path section and/or may be movable to the same and/or that the first path section may be freed from wiping members, for example once a cleaning process is completed.

According to various embodiments, a controller/control unit may for example be provided (for example the above-mentioned controller which is connected to the sensor) which is configured to control the driving device (for example an electric motor thereof) according to different wiping member movement patterns. In other words, various movement patterns may be stored in the controller. A first movement pattern may, for example, comprise/contain a permanent movement of the wiping member in one direction (for example along the above-mentioned circulating path). According to a second movement pattern, the wiping member may, for example, alternately be moved to the left and to the right. Moreover, two movement patterns may, for example, differ in that the wiping member or the wiping members is/are moved at different speeds. Providing different patterns of movement makes it possible to carry out a respectively appropriate cleaning in an efficient way. The controller may, for example, choose a respective movement pattern in accordance with a construction material used and/or a degree of contamination and/or obstruction of the output region (see below) and/or a cleaning interval (i.e., a time lag between two successive cleanings).

According to various embodiments, the 3D printer may, for example, comprise a sensor (“contamination sensor”) which detects a contamination and/or obstruction of the output region of the coating device (for example optically), for example including a degree of contamination and/or obstruction. In this case, the controller may, for example, be configured to choose and perform a corresponding movement pattern in accordance with the contamination and/or obstruction.

According to various embodiments, the coating device cleaning device may for example, be received/arranged in a collection container (for example a tub) (at least in sections). In this respect, the wiping member may, for example, protrude upwards beyond the rim of the container for cleaning the coating device or rather in its cleaning position. Particulate material accrued during the cleaning, for example particulate material that has been brushed off can thus be accumulated in the container, for example in the tub. Moreover, a cleaning of the wiping member itself may take place in the container/tub. The accumulated particulate material may, for example, be recycled.

According to various aspects of the present invention, a 3D printer may comprise a coating device and a coating device cleaning device, wherein the coating device comprises a container which defines an inner cavity for receiving particulate construction material, has an output region for outputting the particulate construction material and can be moved into a cleaning position in which it is arranged above the coating device cleaning device. In this respect, the coating device cleaning device may comprise an elongate carrier structure (for example in the shape of a belt and/or a strap) movable in a circulating way (for example along an inner circulating path) and a wiping member that is attached to the carrier structure. Moreover, the coating device cleaning device may be configured to clean the output region of the coating device when the coating device is located in the coating device cleaning device by moving the carrier structure in a circulating way, whereby the wiping member attached to the carrier structure wipes off the output region of the coating device substantially in a longitudinal direction (for example in a longitudinal direction), for example along the entire longitudinal extension thereof.

The above applies analogously to this 3D printer as well. In this respect, for example the embodiments described in claims 2 to 10 can be applied analogously to this 3D printer as well.

According to various aspects of the present invention, a method for cleaning a coating device of a 3D printer may be provided, wherein the coating device comprises a container which defines an inner cavity for receiving particulate construction material and has an elongate output region for outputting the particulate construction material, and wherein the method comprises:
moving the coating device into a cleaning position in which the coating device is arranged above a coating device cleaning device comprising a wiping member and a driving device for moving/rotationally moving the wiping member, and
moving the wiping member by means of the driving device substantially in a longitudinal direction (for example in a longitudinal direction) of the output region, to wipe and thereby clean the same when the coating device is in the coating device cleaning position.

According to various embodiments, the wiping member may, for example, be moved into a lowered position after cleaning the output region, in order to avoid a collision with the coating device. For example, the wiping manger may be moved on/along a circulating path for this purpose.

According to various embodiments, moving the wiping member may, for example, take place on a closed trajectory.

Apart from that, the comments provided above with respect to the 3D printer or 3D printers apply analogously to the method.

In addition, the following applies both to the method and to the 3D printer or 3D printers:

Particulate construction material within the meaning of this application may be understood as a construction material comprising at least one kind of particulate material (for example (grains of) sand, for example foundry sand, and/or metal particles and/or particles of synthetic material). Several different types of particulate material may be included in the construction material as well, such as a mixture of new sand and recycled sand or a mixture of fine sand and coarse sand or a mixture of two different types of sand. Moreover, the construction material may comprise at least one liquid component, for example a binder component, for example an activator, and/or one or more solid and/or liquid additives. In case that the construction material contains a binder component, another binder component, such as furan resin, may selectively be printed onto a previously applied construction material layer by means of a printing device, so as to solidify this layer in a predetermined area. Depending on the component to be manufactured, for example a casting mold or a foundry core, a construction material composition specifically prepared for this purpose may be used. In this respect, the construction material composition may be defined by the number of components used as well as by the respective type and the respective share of components contained in the construction material (mixture). In this respect, the trickle or flow behavior of the construction material may vary considerably depending on the composition of the construction material. Correspondingly, the temporal occurrence and/or the degree of contamination and thus a necessary cleaning may vary according to the composition of construction material used.

According to various embodiments, the coating device may, for example, be provided with a vibration device by means of which the particulate material received in the inner cavity may be vibrated to influence, for example to support, the flow or trickle behavior of the particulate construction material or the discharge of the particulate construction material from the output region. A vibration device of this type may, for example, be formed by a shaking device by means of which at least a wall portion of the container is vibrated or exposed to a shaking motion to influence the discharge of the particulate construction material. According to various embodiments, also a particulate construction material having a poor trickle or flow behavior may be vibrated appropriately using a vibration device, and/or a wall portion of a container receiving the construction material may be exposed to an appropriate shaking motion using a shaking device.

According to various embodiments, the coating device may, for example, be provided with a labyrinth structure inside the container, which may prevent the construction material from flowing out/escaping when the coating device stands still, and/or with a closing device which enables a selective closing of the output region (for example of the output slot) and comprises, for example, a closing member attached to the coating device.

Exemplary but non-limiting embodiments of the present invention are shown in the Figures and are hereinafter described in detail.

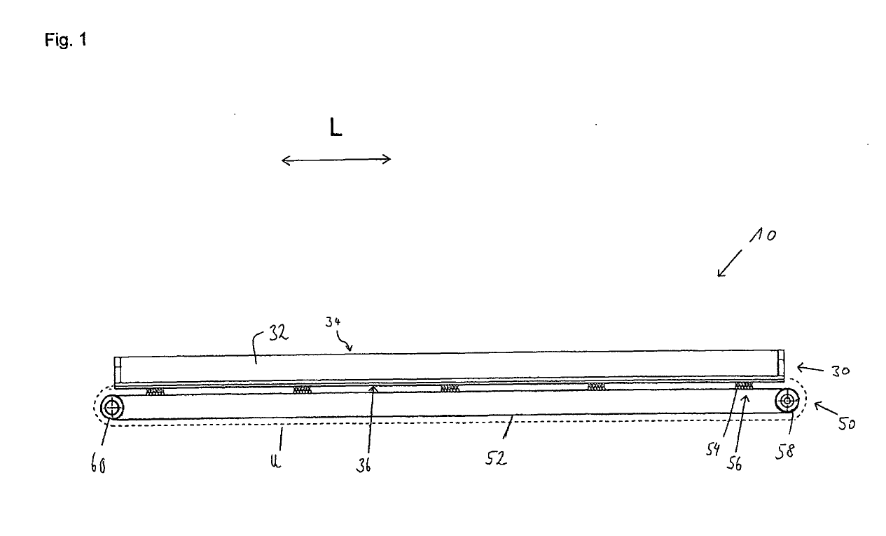

FIG. 1 shows a lateral view of a coating device and of a coating device cleaning device of a 3D printer according to a first embodiment of the present invention,

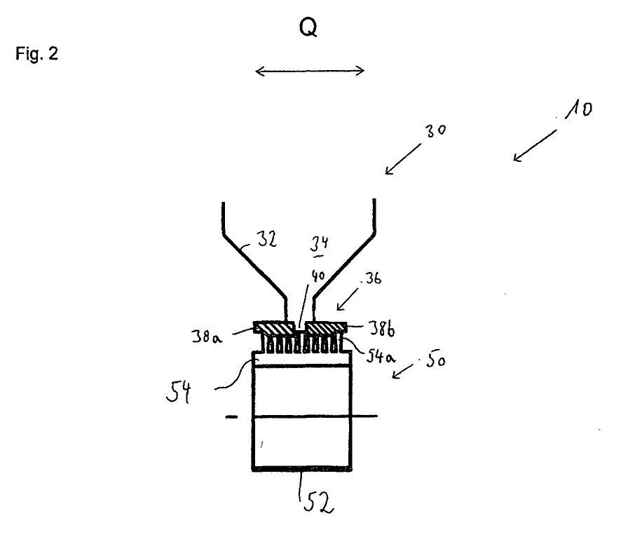

FIG. 2 shows a cross-sectional view of the coating device and of the coating device cleaning device according to FIG. 1,

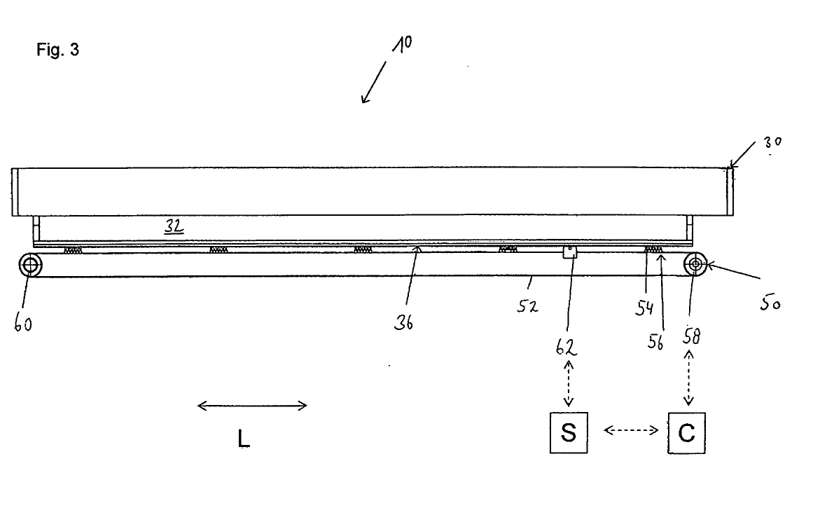

FIG. 3 shows a lateral view of a coating device and of a coating device cleaning device of a 3D printer according to a second embodiment of the present invention, and

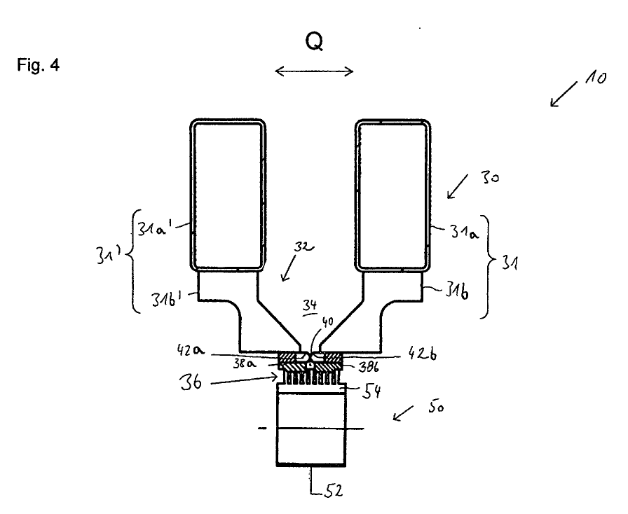

FIG. 4 shows a cross-sectional view of the coating device and of the coating device cleaning device according to FIG. 3.

In the following detailed description, reference is made to the enclosed Figures which are incorporated therein and in which specific embodiments are shown by way of illustration, according to which the invention can be performed. In this respect, the terms “up”, “down”, “front”, “rear”, etc. are used with reference to the orientation in the described Figures. As components of embodiments may be positioned in a number of different orientations, the terminology indicating the different directions serves for illustration and shall not be restrictive in any way.

It shall be understood that other embodiments may be used and structural or logical changes may be made without deviating from the scope of protection of this invention. It goes without saying that the features of the various exemplary embodiments described herein may be combined unless specified otherwise. Thus, the following detailed description should not be understood in a restrictive sense and the scope of protection of the invention shall be defined by the attached claims.

In this description, terms such as “connected”, “attached” and “coupled” may be used to describe both a direct and indirect connection, a direct or indirect attachment and a direct or indirect coupling.

In the Figures, identical or similar members are provided with identical reference numbers where appropriate.

FIG. 1 and FIG. 2 show a schematic, simplified lateral view and sectional view, respectively, of a coating device 30 which, for cleaning its output region 36, is moved into a cleaning position in which it is arranged vertically above a coating device cleaning device 50. The cleaning position may, for example, be located near a construction field of an associated 3D printer 10, which construction field is not shown.

As shown, the coating device 30 comprises a container 32 which defines an inner cavity 34 for receiving particulate construction material. In addition, the coating device 30 has an elongate output region 36 for outputting the particulate construction material onto a construction field.

The coating device cleaning device 50 comprises at least one wiping member 54 and a driving device for moving the wiping member.

Here, a plurality of wiping members 54 is shown by way of example, respectively six wiping members 54 being, by way of example, arranged in a group 56, and altogether five groups 56 of wiping members being provided.

Here, all wiping members 54 are, by way of example, configured as a brush, see especially FIG. 2 which shows the brush trimming 54a, for example in the form of bristles. As illustrated by FIG. 1, the wiping members 54 are distributed in a way to be movable together into a respectively lowered position by means of the driving device, in order to avoid a collision with the coating device 30. In this respect, FIG. 1 shows all wiping members 54 in their respective elevated position; it should, however, be understood that the wiping members 54 may accordingly be movable to a lowered position together.

The driving device is configured to move the wiping members 54 along the output region 36 to clean the same, when the coating device 30 is in the coating device cleaning position.

As shown in FIG. 1, the coating device 30 and the container 32 each have an elongated shape, i.e. an extension in the longitudinal direction L which is greater than an extension in the transverse direction Q. The same applies to the output region 36 which also has an extension in the longitudinal direction L which is greater than its extension in the transverse direction Q. For example, the output region 36 in FIG. 1 may extend substantially over the entire length of the container 32.

As shown in FIG. 2, the output region 36 may comprise an elongated output slot 40 and/or at least one elongated stroking/sweeping surface which is configured to stroke construction material output from the container 32 onto a construction field, in order to thereby level and/or compress the output construction material. Here, the coating device 30 is by way of example configured as a bidirectional coating device, which may apply a layer onto a construction field in both directions (i.e., during a journey to the left and to the right and/or during a journey and a return journey across the construction field), for which purpose the coating device is provided with two elongate stroking surfaces which are here formed by two bar-shaped stroking/sweeping members 38a and 38b or rather by their respective lower side. The two stroking/sweeping members 38a, 38b are arranged in a transverse direction of the coating device (in which direction the coating device can be moved horizontally across a construction field) on opposed sides of the output slot 40, and delimit the same in a transverse direction. It should be understood that the coating device may also be configured as a unidirectional coating device having merely one stroking/sweeping surface and/or one stroking/sweeping member. It is also possible to realize the coating device without stroking surface/stroking member.

As further illustrated by FIG. 2, the (respective) wiping member 54 underlaps the output region 36 in the transverse direction thereof here by way of example entirely, i.e. both the output slot 40 and the two (effective) stroking surfaces which are formed by the lower side of the portion of the respective stroking member 38a, 38b projecting downward, the lower side facing the construction field.

Due to the fact that the driving device is configured to move the wiping members 54 for cleaning the output region 36 along the same, when the coating device 30 is in the coating device cleaning position, i.e. by the wiping off of the output region substantially in the longitudinal direction, the elongate output region 36 can be cleaned effectively and efficiently, for example when compared to a wiping of the output region in the transverse direction thereof, as it is known from the state of the art.

As shown in FIG. 1, the driving device may be configured to move the respective wiping member 54 along a circulating path U (dotted line in FIG. 1), which extends with the first path section along the output region 36 when the coating device 30 is in the coating device cleaning position. Here, the first path section is configured to be linear and extends at/in the output region 36. A second path section which is here also configured to be linear extends underneath the first path section.

In this respect, the driving device may, for example, comprise an elongate carrier structure 52, here in the shape of an endless belt or an endless strap, to which the respective wiping member 54 is attached and which can be moved in a circulating way (for example by means of an electric motor), to thereby move the wiping member along its circulating path.

As shown in FIG. 1, the driving device may, for example, further comprise a first and a second disk 58, 60, one of which can be driven, for example by means of an electric motor (which is not shown), to move the endless strap/ the endless belt and to thereby in turn move the respective wiping member 54.

FIG. 1 and FIG. 2 show a state in which the brushes are in an elevated position and oriented upward, to clean the output region. In normal operation of the 3D printer 10, all brushes may be moved into a lowered position and may be oriented downward, so that the coating device/recoater 30 can be moved across the cleaning position without collision. If the coating device 30 or its output region 36 is to be cleaned, it may be moved to a position above the cleaning device 50 and may be stopped. Then, the brush drive may be turned on or one of the two disks 58, 60 may be rotated (for example by a controller which is not shown), so that the brushes move from their lowered position upward. An appropriate movement pattern of the brushes and of the endless strap/belt, respectively, can help to achieve a desired cleaning effect. For example, the endless strap/belt can be moved permanently in one direction or the endless strap/belt can be moved alternately to the left and to the right. After the output region has been cleaned sufficiently, the brushes may be moved downward again, so that the coating device/recoater 30 may be moved across the cleaning position again without collision.

Now, a 3D printer according to another embodiment of the invention will be described with reference to FIG. 3 and FIG. 4; in this respect, a repeated description of features which the 3D printer has in common with that of FIGS. 1 and 2 shall be omitted as far as possible.

One difference between the 3D printer 10 from FIGS. 3 and 4 and the 3D printer from FIGS. 1 and 2 lies in that the 3D printer 10 or rather the cleaning device 50 according to this embodiment comprises a sensor S which is configured to detect a circulating position of the carrier member 52 and thus a position of the respective wiping member 54. For this purpose, a sensor target 62 may, for example, be attached to the carrier member 52, as shown in FIG. 3. Alternatively or additionally, one or more of the wiping members 54 themselves may, for example, comprise a sensor target 62.

As further illustrated by FIG. 3, the 3D printer 10 may, for example, comprise a controller C connected to the driving device, for example having an electric motor (which is not shown) which drives the disk 58. The controller C may contain one or more movement patterns for cleaning the output region 36.

For example, the sensor and the controller may be connected to each other, so that the position detected by the sensor can be transmitted to the controller.

Apart from that, the coating device cleaning device 50 from FIGS. 3 and 4 is similar to that from FIGS. 1 and 2.

The coating device 30 according to this embodiment may, for example, be configured in the form of a coating device arrangement as it is described in any one of the following documents: DE 10 2014 112 454.5, DE 10 2014 112 450.2, DE 10 2014 112 469.3. The disclosure content of these documents is included herein insofar as the coating device and the coating device arrangement, respectively, is concerned.

Alternatively, the coating device may, for example, be configured as described in any one of the following documents: WO 2011/067303 A2 and DE 10 2009 056 687 A1. The disclosure content of these documents is also included herein insofar as the coating device is concerned.

As shown in FIG. 4, the container 32 may here, by way of example, be arranged/formed between a left carrier structure 31′ and a right carrier structure 31; in this respect, the respective carrier structure may be composed of an upper carrier structure 31a and 31a′, respectively, and a lower carrier structure 31b and 31b′, respectively. In this regard, a wall of the container 32, which is here not illustrated in detail, may, for example, be attached to the right and/or to the left upper carrier structure 31a, 31a′, to extend downward.

In this respect, a so-called charging container may be formed, for example by and/or between the left and right upper carrier structure 31a and 31a′, respectively, and/or a wall structure fixed thereto.

As further illustrated by FIG. 4, a respective closing member 42a and 42b, respectively, and/or a stroking/wiping blade 38a and 38b, respectively, may, for example, be fixed to the left and/or the right lower carrier structure 31b, 31b′. The latter forms on its lower side an elongate stroking surface which is configured to stroke the construction material output from the container, to thereby level and/or compress the output construction material. The closing member 42a and 42b, respectively, may, for example, comprise a portion facing the output slot 40 and being deformable by compressed air; in this respect, a closed state is shown in FIG. 4, in which the respective deformable portion is moved inwards to close the output slot 40, for example for cleaning the output region 36.

The previous description of specific exemplary embodiments of this invention has been presented for the purpose of illustration and description. It is not intended to be exhaustive or to limit the invention to the exact forms disclosed, and it is to be understood that various modifications and variations are possible in the light of the teaching disclosed herein. The exemplary embodiments have been chosen and described to explain certain principles of the invention and their practical application, to hereby enable those skilled in the art to manufacture and use various exemplary embodiments of this invention as well as various alternatives and modifications thereof. It is intended that the scope of protection of the invention shall be defined by the attached claims and their equivalents.

1. 3D printer (10) having a coating device (30) and a coating device cleaning device (50),
wherein the coating device (30) comprises a container (32) which defines an inner cavity (34) for receiving particulate construction material, and an elongate output region (36) for outputting the particulate construction material and is movable into a cleaning position in which it is arranged above the coating device cleaning device (50),
the coating device cleaning device (50) comprising a wiping member (54) and a driving device for moving the wiping member,
characterized in that
the driving device is configured to move the wiping member (54) along the output region (36) for cleaning the same when the coating device (30) is located above the coating device cleaning device (50).

2. 3D printer (10) according to claim 1, wherein the driving device is configured to move the wiping member (54) into a lowered position, in order to avoid a collision with the coating device (30).

3. 3D printer (10) according to claim 1 or 2, wherein the driving device is configured to move the wiping member (54) along a circulating path (U) extending with a first path section along the output region (36) when the coating device (30) is in the coating device cleaning position.

4. 3D printer (10) according to claim 3, wherein the driving device comprises an elongate carrier structure (52) to which the wiping member (54) is attached and which is movable in a circulating manner, to thereby move the wiping member along its circulating path.

5. 3D printer (10) according to any one of the preceding claims, wherein the output region (36) has a transverse extension and wherein the wiping member (54) predominantly or substantially completely underlaps the output region in the transverse direction thereof.

6. 3D printer (10) according to any one of the preceding claims, wherein the wiping member (54) is configured as a brush.

7. 3D printer (10) according to any one of the preceding claims, wherein the output region (36) comprises an elongate output slot (40) and/or at least one elongate stroking surface which is configured to stroke construction material output from the container (32), to thereby level and/or compress the output construction material.

8. 3D printer (10) according to any one of the preceding claims, further comprising a sensor (S) which is configured to detect a position of the wiping member (54).

9. 3D printer (10) according to any one of the preceding claims, the coating device cleaning device (50) comprising a plurality of wiping members (54).

10. 3D printer (10) according to claim 9, wherein the wiping members (54) are movable together into a respectively lowered position, to avoid a collision with the coating device (30).

11. 3D printer (10) having a coating device (30) and a coating device cleaning device (50),
wherein the coating device (30) comprises a container (32) which defines an inner cavity (34) for receiving particulate construction material, has an output region (36) for outputting the particulate construction material and is movable into a cleaning position in which it is arranged above the coating device cleaning device (50),
the coating device cleaning device (50) comprising:
an elongate carrier structure (52) movable in a circulating manner, and
a wiping member (54) attached to the carrier structure,
wherein the coating device cleaning device (50) is configured to clean the output region (36) of the coating device (30) when the coating device is located in the coating device cleaning device, by the carrier structure (52) being moved in the circulating manner, whereby the wiping member (54) attached to the carrier structure wipes the output region (36) of the coating device substantially in a longitudinal direction.

12. Method for cleaning a coating device (30) of a 3D printer (10), wherein the coating device (30) comprises a container (32) which defines an inner cavity (34) for receiving particulate construction material and has an elongate output region (36) for outputting the particulate construction material, comprising:
moving the coating device (30) into a cleaning position in which the coating device is arranged above a coating device cleaning device (50) comprising a wiping member (54) and a driving device for moving the wiping member,
characterized by
moving the wiping member (54) by means of the driving device substantially in a longitudinal direction of the output region (36), to wipe off and thereby clean the same when the coating device is in the coating device cleaning device.

13. Method according to claim 12, wherein the wiping member (54) is moved into a lowered position after cleaning the output region, to avoid a collision with the coating device (30).

14. Method according to claim 12 or 13, wherein moving the wiping member takes place on a closed trajectory.
